(19) United States
(12) Patent Application Publication
(10) Pub. No.: US 2004/0192286 A1
(43) Pub. Date: Sep. 30, 2004

(54) Adaptive dispatch paging monitoring system and method

(75) Inventors: Audrey Longhurst, Seattle, WA (US); Wayne W. Ballantyne, Coconut Creek, FL (US); Mitchell E. Renko, Coral Springs, FL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/403,373

(22) Filed: Mar. 31, 2003

(51) Int. Cl. H04Q 7/20

(52) U.S. Cl. 455/422.1; 455/445

(57) ABSTRACT

A subscriber unit (102) monitors a percentage of slots in a control channel (108) for a time period, and determines a utilization of the control channel (108) during the time period based upon the percentage of slots monitored. A percentage of slots in the control channel 108 to monitor for a page during a subsequent time period is selected based upon the utilization of the control channel (108) during the time period. The percentage of slots monitored during the subsequent time period may be adjusted based upon relative usage of page types in the control channel (408), recent call activity (410), and received signal strength (412).

### TECHNICAL FIELD

This invention relates in general to mobile communication devices, and more particularly to methods of reducing power consumption in mobile communication devices.

### BACKGROUND OF THE INVENTION

Mobile communication devices have become widespread in metropolitan areas throughout the world. There are a variety of types of mobile communication devices including cell phones, walkie-talkies, and cell phones that support dispatch call processing (walkie-talkie type communications). Of concern to the users are the size and weight of the mobile communication device; therefore, manufacturers have continued to reduce both the size and weight of such devices. One of the largest and heaviest components in any mobile communication device is the battery. This presents a problem because, in addition to size and weight, users are also interested in lengthy operation time without having to recharge or change a battery, and while a larger battery permits longer operation time, it increases the effective size and weight of the mobile communication device. Some advances in battery technology have allowed for smaller batteries compared to earlier batteries of equal energy capacity. The use of smaller batteries, however, has largely been made possible by reducing the power consumption of the mobile communication device, thereby allowing use of a smaller battery for equal operation time.

The push for lower power consumption has led to many innovative approaches to designing mobile communication devices, and manufacturers continue to seek ways to reduce power consumption. Such efforts have led to lower voltage semiconductor devices, integration of sub-circuits formerly implemented with discrete components into monolithic packages, and other circuit level advance. At the same time, control of the various circuits through software has led to many advances in reducing power consumption.

Despite hardware and hardware control advances, mobile communication devices are required to comply with the air interface for events including, for example, receiving incoming call page alerts. Page alerts are messages sent over a control channel in page slots to alert a given mobile communication device that there is an incoming call. When the mobile communication device receives the page alert, it can alert the user of the mobile communication device accordingly, and the user can then commence communicating.

Because page alerts can occur randomly, the mobile communication device needs to regularly check for page alerts and other messages. Typically the mobile communication device checks the air interface by monitoring the control channel for page alerts having specific identification information. If it receives a page alert with the appropriate identification information, i.e., indicating an incoming call intended the particular mobile communication device, the mobile communication device takes appropriate action to receive the call.

Typically, the mobile communication device monitors only a small portion of each page slot for a page alert with appropriate identification information, but monitoring even a portion of each page slot of the control channel for pages shortens the battery life due to the higher power consumption compared to an idle mode.

### BRIEF DESCRIPTION OF THE DRAWINGS

FIG. 1 is a block diagram of a communication system in accordance with one embodiment of the invention;

FIG. 2 is a block diagram of a subscriber unit of FIG. 1 according to one embodiment;

FIG. 3 is a flowchart showing steps traversed by the subscriber unit of FIG. 2 in carrying out an adaptive dispatch-paging monitoring algorithm according to one embodiment of the present invention; and

FIG. 4 is a flowchart showing steps traversed by the subscriber unit of FIG. 2 in carrying out the adaptive dispatch-paging monitoring algorithm according to another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a subscriber unit monitors a percentage of slots in a control channel during some time period, and then determines a degree of utilization of the control channel during this time period based, at least in part, upon a level of utilization of the monitored slots. The subscriber unit can then select a percentage of slots in the control channel to monitor for a page during subsequent periods of operation in a manner based, at least in part, upon the utilization of the control channel during the earlier time period. In one embodiment, one or more threshold levels can be used to facilitate an analysis of the level of control channel utilization. In a preferred embodiment, the subscriber unit will monitor the control channel by monitoring, in particular, a selection of paging slots contained therein.

In a preferred embodiment, these processes are facilitated through use of a programmable platform having access to a computer readable medium, wherein the medium is encoded with one or more appropriate computer programs. Such a program (or programs) will preferably include a code segment for monitoring the control channel for a time period, a code segment for determining a level of utilization of the control channel during the time period based upon the slots monitored during the time period, and a code segment for selecting a percentage of slots in the control channel to monitor for a page during a subsequent time period based upon the utilization of the control channel during the time period.

So configured, a subscriber unit can effectively monitor and remain usefully cognizant of pages intended for the subscriber unit such that the subscriber unit can respond in a relatively timely and appropriate manner while simultaneously substantially minimizing the amount of current, and hence battery power, required to support this capability.

While the specification concludes with claims defining the features of the invention that are regarded as novel, it is believed that the invention will be better understood from a consideration of the following description in conjunction with the drawing figures, in which like reference numerals are carried forward.

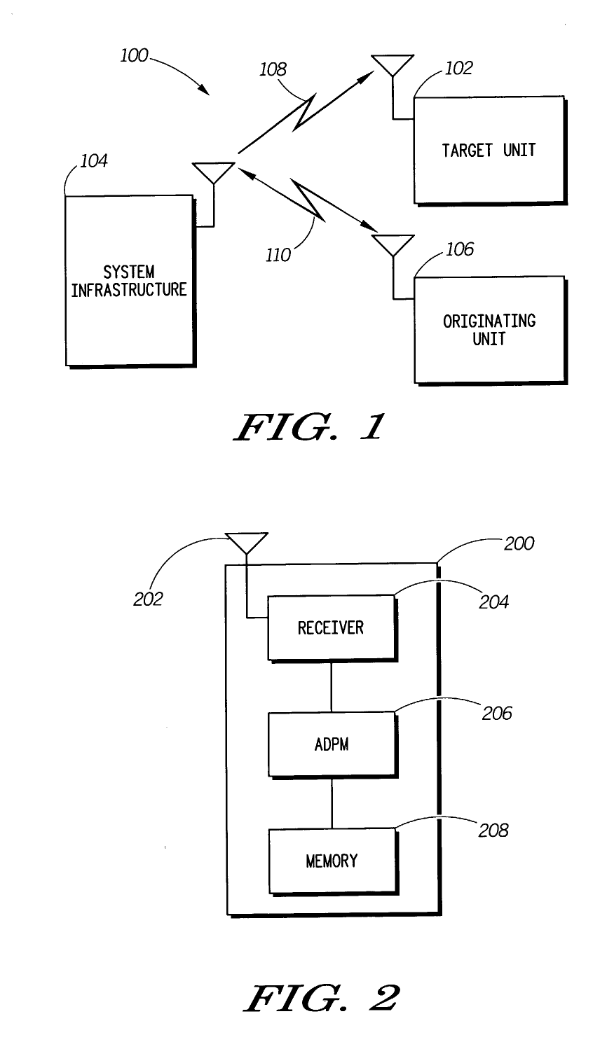

Referring first to FIG. 1, there is shown a system diagram of a communication system 100 in accordance with one embodiment of the invention. Also shown in the communication system 100 are a target unit 102, system infrastructure 104, an originating unit 106 and control channels 108, 110.

In several embodiments, the communication system 100 operates according to an integrated digital enhanced network that provides digital wireless telephony and dispatch call processing capability. Digital wireless telephony, referred to herein as interconnect call processing, describes a function of the communication system 100 that provides communications between both the subscriber units 102, 106 and/or an outside network (not shown), e.g., a public switched telephone network. Dispatch call processing describes a walkie-talkie type function of the communication system that provides communication between the subscriber units 102, 106, e.g., through the system infrastructure 104, without having to route signals through another network.

The control channels 108, 110 are communication links between the system infrastructure 104 and the subscriber units 102, 106. Information is communicated over the control channels 108, 110 via page slots which the subscriber units 102, 106 monitor for page alerts, e.g., dispatch and interconnect page alerts, which signal to the subscriber units 102, 106 that they are being hailed from another communication device. In some embodiments, for example, the communication system 100 operates according to Motorola's iDEN® communication system and the control channel 108 is an outbound control channel that provides, for example, a 15 millisecond outbound paging slot roughly every 90 milliseconds.

The subscriber units 102, 106 according to several embodiments are two-way communicating devices that support multiple logical and/or physical channels, and as discussed, both the subscriber units 102, 106 monitor the control channels 108, 110 for page alerts.

In operation, when the originating unit 106 desires to communicate with the target unit 102, the target unit 102 sends a call request via control channel 110 to the system infrastructure 104. The call request includes an identification of the target unit 102, and the system infrastructure 104 receives the call request and encodes a page alert, which includes information identifying the target unit 102, on a number of the page slots of the control channel 108. The number of page slots that the page alert is encoded on depends upon a utilization level of the control channel 108. For example, if the control channel 108 is lightly utilized, the page alert will be repeated several times on several page slots, but if the control channel 108 is heavily utilized the page alert is repeated a fewer number of times.

In prior art systems, the target unit 102 monitors every page slot for dispatch pages. Monitoring every page slot for dispatch pages allows the target unit 102 to receive calls while reducing delay, and importantly, prevents the target unit 102 from missing page alerts. The drawback with monitoring every page slot of the control channel 108 is that monitoring the control channel 108 for page alerts requires energy that reduces the battery life of the target unit 102.

According to several embodiments of the invention, an adaptive dispatch paging monitor (ADPM) algorithm is provided at a subscriber unit (e.g. the target unit 102) to select a number of paging slots to monitor for page alerts as a function of the utilization of the control channel 108. In this way, the ADPM algorithm takes advantage of the repetition of dispatch page alerts that are sent over the control channel 108 by monitoring fewer than all the paging slots.

It should be recognized that the ADPM algorithm is not limited to applications where a subscriber unit monitors every paging slot for a dispatch page alert. For example, the ADPM algorithm is also applicable to a communication system that utilizes dispatch paging subchannels. Although energy is saved in a system utilizing dispatch paging subchannels because only a particular recurring time slot needs to be monitored for page alert messages, if any exist, page alerts are still repeated by the system infrastructure 104 a number of times depending upon utilization of the control channel 108 in case the target unit 102 misses it.

Advantageously, the ADPM algorithm, according to several embodiments, is implemented completely in the subscriber units 102, 106, and thus, does not require a change in the infrastructure of the communication system 100. Therefore, the ADPM algorithm is a low cost option that can be implemented quickly and introduced compatibly into existing systems.

Referring next to FIG. 2, shown is a functional block diagram of a subscriber unit of FIG. 1 according to one embodiment. Shown within the subscriber unit is an antenna 202, a receiver portion 204, an adaptive dispatch paging monitor portion 206 (also referred to herein as an ADPM portion 206) and a memory element 208.

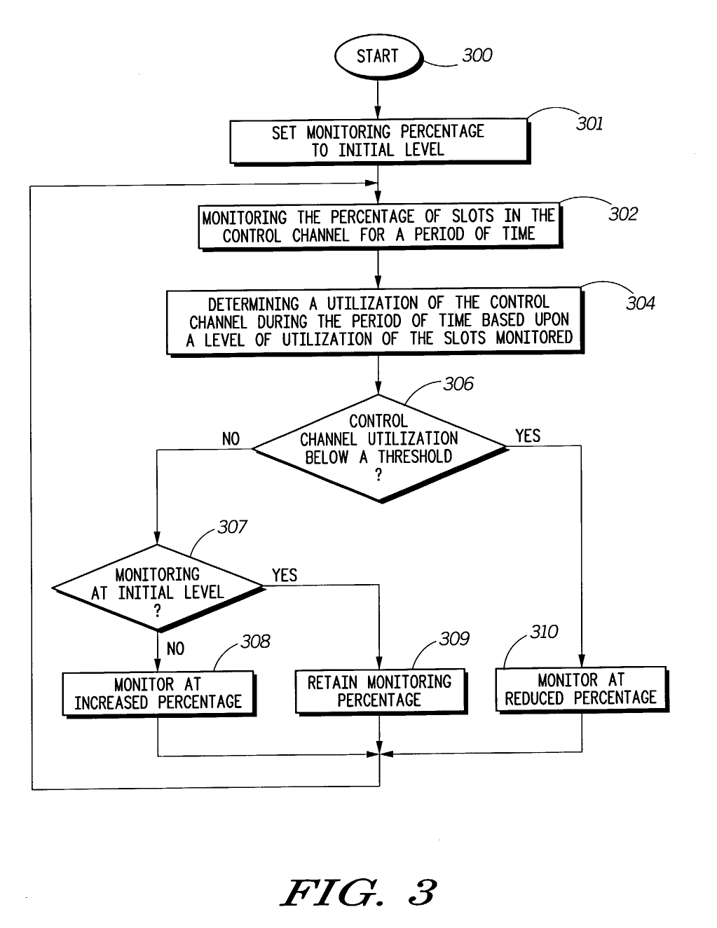

While referring to FIG. 2, simultaneous reference will be made to FIG. 3 which is a flowchart showing steps traversed by the subscriber unit, e.g., the target unit 102, in carrying out the ADPM algorithm according to one embodiment of the present invention.

Initially, after the target unit 102 is turned on (Step 300 of FIG. 3) and the receiver portion 204 has captured the control channel 108, the ADPM portion 206 sets a monitoring level to an initial level (Step 301 of FIG. 3). Next, the ADPM portion 206 begins to monitor the control channel for a period of time (Step 302 of FIG. 3). For example, the ADPM portion 206 may monitor the control channel 108 for a period ranging from a few seconds to few minutes.

During an initial time period, e.g., when the ADPM portion 206 is first monitoring the control channel, the initial monitoring level, in several embodiments, is 100% so that all paging slots where a page alert may be present are monitored. For example, in embodiments where the infrastructure 104 of the communication system 100 does not accommodate paging subchannels, the ADPM portion 206 monitors every paging slot for a dispatch page. In embodiments where the infrastructure 104 supports paging subchannels, page alerts may exist only in certain paging slots, and 100% percent of the paging slots where a page alert may exist are monitored.

While monitoring the control channel, the ADPM portion 206 relays information to the memory 208 indicating an amount of usage present on each monitored paging slot. After the monitoring time period is complete, the ADPM portion 206 retrieves the usage information for each monitored paging slot over the time period and determines an overall utilization of the control channel during the period of time the control channel was monitored (Step 304 of FIG. 3). In some embodiments, the overall utilization is an average of the utilization of paging slots during the monitoring window.

Once a utilization level for the control channel 108 is determined (Step 304 of FIG. 3), the utilization level is compared with a threshold level, and if the utilization level is above the threshold level (Step 306 of FIG. 3), and the monitoring level is at the initial level (Step 307 of FIG. 3), i.e., it has not been reduced, the monitoring level of the control channel is left unchanged (Step 309 of FIG. 3). For example, all the paging slots that were monitored at Step 302 will be monitored again during a new monitoring window.

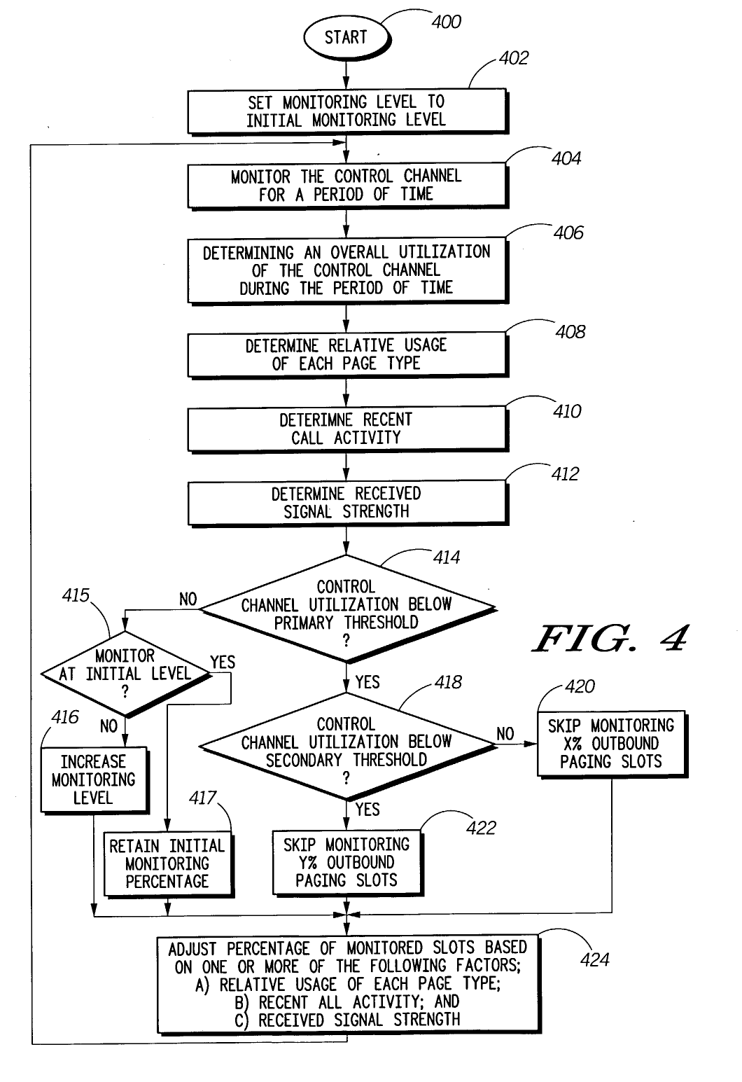

If, however, the utilization level of the control channel 108 is below the threshold level, the percentage of paging slots monitored is lowered (Step 310 of FIG. 3) so that when the control channel 108 is monitored again (Step 302 of FIG. 3) during a subsequent time period some of the paging slots are skipped. A utilization level is then determined based on the reduced number of paging slots that are actually monitored (Step 304 of FIG. 4), and if utilization is no longer below the threshold (Step 306 of FIG. 3), then the percentage of slots monitored is increased (Step 308 of FIG. 3), e.g., to the initial monitoring level.

If the utilization level of the reduced number of paging slots actually monitored is still below the threshold level, then the reduced percentage of paging slots are again monitored (Steps 310 and 302 of FIG. 3).

Thus, the target unit 102, according to several embodiments, monitors the control channel on an ongoing basis and adapts the percentage of paging slots monitored as a function of the utilization of the control channel. In this way, the target unit 102 reduces the number of paging slots monitored, and hence, the amount of energy expended when page alerts intended for the target unit 102 are repeated more often.

In some embodiments, the threshold level is a predetermined threshold level, e.g., a30% utilization threshold, which is established by an operator of the communication system 100. In other embodiments, as discussed further with reference to FIG. 4, there may be multiple threshold levels, and a percentage of paging slots that are monitored based upon the threshold levels may be adjusted further depending upon other factors affecting communications within the communication system 100.

It is noted that many of the steps performed by the functional blocks of the receiver portion 204, and the ADPM portion 206 may be implemented as a set of instructions encoded in software or firmware that are performed in dedicated hardware, e.g., using a processor or other machine to execute the instructions to accomplish the provided functionality. For example, in one embodiment, the ADPM portion 206 may be implemented with a combination of a microcontroller and a digital signal processor that may be implemented as one or more integrated circuit (IC) devices. One of ordinary skill in the art recognizes, however, that various hardware configurations well within the scope of the present invention may be implemented to carry out the steps of the ADPM algorithm.

Referring next to FIG. 4, shown is a flowchart illustrating steps traversed by subscriber unit of FIG. 2 in carrying out another embodiment of the ADPM algorithm.

In the present embodiment, after the subscriber unit 200 is powered up (Step 400 of FIG. 4) and the percentage of paging slots monitored is set to an initial level (Step 402 of FIG. 4), the subscriber unit 200 not only monitors the control channel 108 for a period of time (Step 404 of FIG. 4) and determines an overall utilization of the control channel 108 during the period of time (Step 406 of FIG. 4), but also considers other factors, in addition to control channel utilization, to determine a percentage of outbound paging slots to skip when monitoring the control channel 108.

For example, because the control channel 108 potentially carries packet data pages, interconnect pages and dispatch pages, the control channel 108 may be heavily utilized, but not by dispatch pages, and in such a situation there is a decreased likelihood that a dispatch page will be sent; thus, the number of monitored paging slots may be reduced. Therefore, in some embodiments, after monitoring the control channel 108 for a period of time (Step 404 of FIG. 4), in addition to determining total utilization of the control channel (Step 406 of FIG. 4), relative usage of each page type, e.g., dispatch or interconnect, on the control channel 108 is determined (Step 408 of FIG. 4).

Additionally, there is an increased statistical likelihood that if a user just sent or received a call, or several calls, that there will likely be more call traffic coming in for the user, and in such instances, it is often desirable to monitor more paging slots. Thus, in some embodiments recent call activity is determined (Step 410 of FIG. 4).

Yet another useful factor is the received signal strength of signals received over the control channel 108. Generally, when the received signal strength of signals over the control channel 108 is relatively low, the probability the subscriber unit 200 will receive and correctly decode page alerts is less than when the received signal strength of the control channel is relatively high. Thus, in some embodiments received signal strength is determined (Step 412 of FIG. 4), and is used as a factor to establish whether it is appropriate to reduce the percentage of paging slots monitored, e.g., when RSSI is weak, more paging slots would be monitored.

In addition to factoring in recent call activity and received signal strength, in some embodiments, multiple threshold levels of overall control channel utilization are established that are used to determine a percentage of paging slots to monitor. For example, if utilization of the control channel 108 is above a primary threshold (Step 414 of FIG. 4), e.g., a 60% utilization threshold, and the monitoring level at Step 404 is at the initial level (415 of FIG. 4), then the subscriber unit continues to monitor outbound paging slots at the initial level (Step 417 of FIG. 4). If utilization of the control channel 108 is below the primary threshold, but is above a secondary threshold (Step 418 of FIG. 4), e.g., a 30% control channel utilization threshold, then monitoring of the control channel 108 is reduced to, for example, 50% of the paging slots (Step 420 of FIG. 4). If the control channel utilization is below the secondary threshold (Step 418 of FIG. 4), then even more outbound paging slots are skipped (Step 422 of FIG. 4), e.g., 75% of the paging slots are skipped.

If control channel monitoring has been reduced, i.e., the monitoring level is no longer at the initial level (Step 415 of FIG. 4), and subsequent monitoring of the control channel (Step 404 of FIG. 4) indicates that control channel utilization has increased over the previous level(s) to exceed the primary threshold (Step 414 of FIG. 4) then the percentage of paging slots monitored is increased (Step 416 of FIG. 4). In some embodiments, the percentage of paging slots monitored is increased to the initial monitoring level, e.g., to monitor 100% of the paging slots.

In some embodiments, after a percentage of paging slots to skip is determined from the level of overall utilization of the control channel (Steps 414-422 of FIG. 4), the percentage of paging slots skipped is adjusted depending upon one or more of the factors previously determined, i.e., the relative usage of each page type, the recent call activity and the received signal strength (Step 424 of FIG. 4). In other embodiments, a portion or all of the detennined factors in Steps 408-412 are used to determine whether or not the utilization of the control channel 108 is even considered. For example, if the received signal strength is very low, in some embodiments, all paging slots continue to be monitored and the utilization of the control channel 108 is not a factor.

While primary and secondary threshold utilization levels are discussed with reference to FIG. 4, it should be recognized that there may be additional threshold levels to further define monitoring levels of the control channel. Furthermore, in some embodiments, when the percentage of paging slots monitored has been reduced because control channel utilization during previous monitoring was relatively low, e.g., below one or more threshold levels, and the control channel utilization begins to increase, the percentage of paging slots monitored is increased in a step-wise fashion. In other embodiments, however, a detected increase in control channel utilization based upon monitoring of a reduced number of paging slots prompts the level of monitoring to revert completely back to the initial monitoring level.

It should be recognized that both the specific threshold utilization percentages set forth above, and the specific percentage of paging slots skipped are exemplary only and that these may vary based upon a number of factors. Furthermore, the factors set forth above, e.g., recent call activity, may be weighted by routine experimentation for the particular air interface and for certain conditions.

It should also be recognized that while the method of the present invention illustrated by the flowchart description above is described and shown with reference to specific steps performed in a specific order, these steps may be combined, subdivided, or reordered without departing from the scope of the claims. Unless specifically stated herein, the order and grouping of steps is not a limitation of the present invention.

Furthermore, the preferred embodiments of the invention have been illustrated and described, but it will be clear that the invention is not so limited. Numerous modifications, changes, variations, substitutions and equivalents will occur to those skilled in the art without departing from the spirit and scope of the present invention as defined by the appended claims.

What is claimed is:

1. A method of monitoring a control channel for a page at a subscriber unit, comprising:
monitoring a percentage of slots in the control channel during a time period;
determining a utilization of the control channel during the time period based upon a level of utilization of the slots monitored; and
selecting a percentage of slots in the control channel to monitor for a page during a subsequent time period based upon the utilization of the control channel during the time period.

2. The method of monitoring the control channel as defined in claim 1, wherein the step of selecting a percentage of slots in the control channel to monitor is based upon whether the utilization of the control channel during the time period is below one of a plurality of threshold levels.

3. The method of monitoring the control channel as defined in claim 1, wherein the step of monitoring further comprises monitoring a percentage of a particular selection of paging slots wherein the particular selection of paging slots is determined, at least in part, by a paging subchannel protocol.

4. The method of monitoring the control channel as defined in claim 1, wherein the step of monitoring the percentage of slots in the control channel during the time period comprises monitoring all paging slots in the control channel during the time period.

5. The method of monitoring the control channel as defined in claim 1, further comprising:
measuring a received signal strength from the control channel;
wherein the step of selecting the percentage of slots in the control channel to monitor comprises selecting the percentage of slots in the control channel to monitor for the page based in part upon the received signal strength of the control signal.

6. The method of monitoring the control channel as defined in claim 1, further comprising:
monitoring recent call activity;
wherein the step of selecting the percentage of slots in the control channel to monitor for the page comprises selecting the percentage of slots in the control channel to monitor for the page based in part upon the recent call activity.

7. The method of monitoring the control channel as defined in claim 1, wherein the step of monitoring comprises monitoring the percentage of slots for a particular page type during the time period;
wherein the step of determining a utilization of the control channel during the time period comprises determining a percent of the utilization of the control channel during the time period due to the particular page type;
wherein the step of selecting the percentage of slots in the control channel to monitor comprises selecting the percentage of slots in the control channel to monitor for the page based in part upon the percent of the utilization of the control channel due to the particular page type.

8. A computer readable medium encoded with a computer program for adapting monitoring of a control channel comprising:
a code segment for monitoring the control channel for a time period;
a code segment for determining a level of utilization of the control channel during the time period based upon the slots monitored during the time period; and
a code segment for selecting a percentage of slots in the control channel to monitor for a page during a subsequent time period based upon the utilization of the control channel during the time period.

9. The computer readable medium of claim 8, wherein the code segment for selecting a percentage of slots in the control channel to monitor comprises a code segment for selecting a percentage of slots in the control channel to monitor is based upon whether the utilization of the control channel during the time period is below one of a plurality of threshold levels.

10. The computer readable medium of claim 8, wherein the code segment for monitoring further comprises a code segment for monitoring a percentage of a particular selection of paging slots wherein the particular selection of monitored paging slots is determined, at least in part, by a paging subchannel protocol.

11. The computer readable medium of claim 8, wherein the code segment for monitoring the control channel for the period of time comprises a code segment for monitoring all paging slots in the control channel during the period of time.

12. The computer readable medium of claim 8 further encoded with a computer program comprising:
a code segment for obtaining a measured received signal strength from the control channel;
wherein the code segment for selecting the percentage of slots in the control channel to monitor comprises a code segment for selecting the percentage of slots in the control channel to monitor for the page based in part upon the measured received signal strength of the control signal.

13. The computer readable medium of claim 8, further encoded with a computer program comprising:
a code segment for monitoring recent call activity;
wherein the code segment for selecting the percentage of slots in the control channel to monitor for the page comprises a code segment for selecting the percentage of slots in the control channel to monitor for the page based in part upon the recent call activity.

14. The computer readable medium of claim 8, wherein the code segment for monitoring comprises a code segment for monitoring the percentage of slots for a particular page type during the time period;
wherein the code segment for determining a utilization of the control channel during the time period comprises a code segment for determining a percentage of the utilization of the control channel during the time period due to the particular page type;
wherein the code segment for selecting the percentage of slots in the control channel to monitor comprises a code segment for selecting the quantity of slots in the control channel to monitor for the page based in part upon the percent of the utilization of the control channel due to the particular page type.

15. An adaptive page monitoring device for a subscriber unit comprising:
means for monitoring a percentage of slots in the control channel during a time period;
means for determining a utilization of the control channel during the time period based upon a level of utilization of the slots monitored; and
means for selecting a percentage of slots in the control channel to monitor for a page during a subsequent time period based upon the utilization of the control channel during the time period.

16. The adaptive page monitoring device of claim 12, wherein the means for selecting a percentage of slots in the control channel to monitor is based upon whether the utilization of the control channel during the time period is below one of a plurality of threshold levels.

17. The adaptive page monitoring device of claim 12, wherein the means for monitoring the control channel for the time period comprises means for monitoring all paging slots in the control channel for the time period.

18. The adaptive page monitoring device of claim 12 further comprising:
means for measuring a received signal strength from the control channel;
wherein the means for selecting the percentage of slots in the control channel to monitor comprises means for selecting the percentage of slots in the control channel to monitor for the page based in part upon the received signal strength of the control signal.

19. The adaptive page monitoring device of claim 12, further comprising:
means for monitoring recent call activity;
wherein the means for selecting the percentage of slots in the control channel to monitor comprises means for selecting the percentage of slots in the control channel to monitor for the page based in part upon the recent call activity.

20. The adaptive page monitoring device of claim 16, wherein the means for monitoring comprises means for monitoring the percentage of slots for a particular page type during the period of time;
wherein the means for determining a utilization of the control channel during the time period comprises means for determining a percentage of the utilization of the control channel due to the particular page type during the time period;
wherein the means for selecting the percentage of slots in the control channel to monitor comprises means for selecting the percentage of slots in the control channel to monitor for the page based in part upon the percent of the utilization of the control channel due to the particular page type.
